(19) United States
(12) Patent Application Publication
(10) Pub. No.: US 2017/0336749 A1
(43) Pub. Date: Nov. 23, 2017

(54) RELAY CONNECTOR FITTING STRUCTURE, ELECTRONIC APPLIANCE, AND IMAGE FORMING APPARATUS

(71) Applicant: KYOCERA Document Solutions Inc., Osaka (JP)

(72) Inventors: Satoshi ANDO, Osaka (JP); Ryo MATSUYAMA, Osaka (JP)

(73) Assignee: KYOCERA Document Solutions Inc., Osaka (JP)

(21) Appl. No.: 15/592,801

(22) Filed: May 11, 2017

(30) Foreign Application Priority Data
May 20, 2016 (JP) 2016-101658

(51) Int. Cl. G03G 15/00; H01R 13/629

(52) U.S. Cl. CPC G03G 15/80; H01R 13/629

(57) ABSTRACT

An relay connector fitting structure has a connector, a relay connector, and a chassis. The relay connector is removably fitted with the connector. The chassis has a fitting surface. The chassis has, formed integrally with it, a first stopper restricting movement of the relay connector in a first direction, a second stopper restricting movement of the relay connector in a second direction, and an opposite surface stopper restricting movement of the relay connector to the side opposite from the fitting surface.

### INCORPORATION BY REFERENCE

This application is based upon and claims the benefit of priority from the corresponding Japanese Patent Application No. 2016-101658 filed on May 20, 2016, the entire contents of which are incorporated herein by reference.

### BACKGROUND

The present disclosure relates to a relay connector fitting structure, an electronic appliance, and an image forming apparatus. More particularly, the present disclosure relates to a structure for fitting a relay connector to a chassis having a fitting surface, and to an electronic appliance and an image forming apparatus provided with such a structure.

In electronic appliances such as image forming apparatuses and personal computers, electrical wiring such as between one circuit board and another and between a circuit board and an electronic component is achieved not only by direct connection using cables but also by use of relay connectors which connect together connectors provided at end parts of cables. Such relay connectors are fitted to a structural member such as a chassis by use of screws and hooks.

### SUMMARY

According to one aspect of the present disclosure, a relay connector fitting structure includes a connector, a relay connector, and a chassis. The connector is provided at an end part of a cable. The relay connector is removably fitted with a plurality of connectors. The chassis has a fitting surface to which the relay connector is fitted. The relay connector has a facing surface arranged to face the fitting surface, a plurality of side surfaces arranged upright from the end edges of the facing surface, and an opposite surface arranged on the side opposite from the facing surface. The chassis has, formed integrally with it, a first stopper which is arranged to face a first side surface—one of the plurality of side surfaces of the relay connector arranged in a first direction—and which restricts movement of the relay connector in the first direction, a second stopper which is arranged to face a second side surface—one of the plurality of side surfaces of the relay connector arranged in a second direction opposite to the first direction—and which restricts movement of the relay connector in the second direction, and an opposite surface stopper which is arranged to face the opposite surface of the relay connector and which restricts movement of the relay connector to the side opposite from the fitting surface.

Further features and advantages of the present disclosure will become apparent from the description of embodiments given below.

### BRIEF DESCRIPTION OF THE DRAWINGS

FIG. 1 is a sectional view showing the structure of an image forming apparatus provided with a relay connector fitting structure according to a first embodiment of the present disclosure;

FIG. 2 is a plan view showing the structure of a container lock mechanism including the relay connector fitting structure according to the first embodiment of the present disclosure;

FIG. 3 is a perspective view showing the relay connector fitting structure according to the first embodiment of the present disclosure;

FIG. 4 is a perspective sectional view showing the relay connector fitting structure according to the first embodiment of the present disclosure;

FIG. 5 is a perspective view showing the structure of a chassis to which the relay connector according to the first embodiment of the present disclosure is fitted;

FIG. 6 is a perspective view showing the relay connector according to the first embodiment of the present disclosure fitted to the chassis;

FIG. 7 is a perspective view showing a relay connector fitting structure according to a second embodiment of the present disclosure;

FIG. 8 is a perspective sectional view showing the relay connector fitting structure according to the second embodiment of the present disclosure;

FIG. 9 is a perspective view showing the structure of a chassis to which the relay connector according to the second embodiment of the present disclosure is fitted;

FIG. 10 is a perspective view showing a relay connector fitting structure according to a third embodiment of the present disclosure;

FIG. 11 is a perspective sectional view showing the relay connector fitting structure according to the third embodiment of the present disclosure; and

FIG. 12 is a perspective view showing the structure of a chassis to which the relay connector according to the third embodiment of the present disclosure is fitted.

### DETAILED DESCRIPTION

Embodiments of the present disclosure will be described below with reference to the accompanying drawings.

### First Embodiment

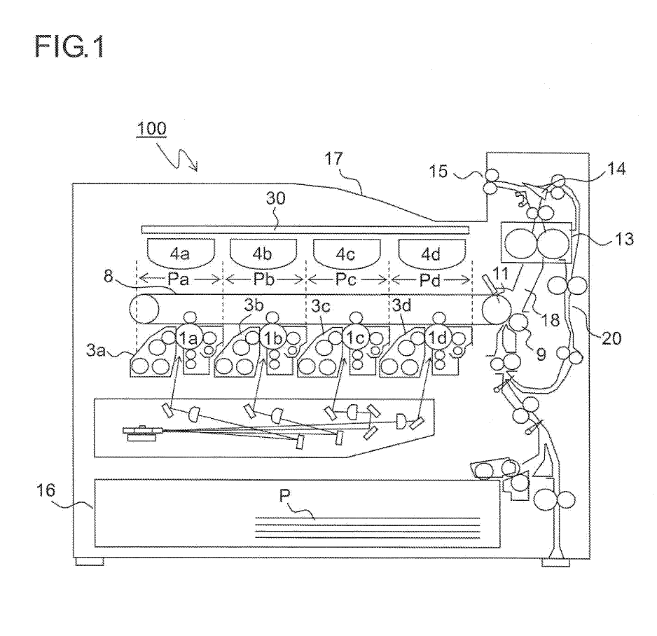

FIG. 1 is a sectional view showing the structure of an image forming apparatus (electronic appliance) 100 provided with a structure for fitting relay connectors 52a to 52d according to a first embodiment of the present disclosure, and depicts here a tandem-type color image forming apparatus. Inside a main body of the image forming apparatus 100, four image forming sections Pa, Pb, Pc, and Pd are arranged in this order from the upstream side (in FIG. 1, the left side) in the conveying direction. These image forming sections Pa to Pd are provided to correspond to four different colors (cyan, magenta, yellow, and black), and form a cyan, a magenta, a yellow, and a black image successively, each through the processes of electrostatic charging, exposure, development, and transfer.

In the image forming sections Pa to Pd, there are arranged photosensitive drums (image carriers) 1a, 1b, 1c, and 1d which carry visible images (toner images) of the different colors, and next to the image forming sections Pa to Pd, there is provided an intermediary transfer belt 8 which rotates counter-clockwise in FIG. 1 by being driven by a driving means (unillustrated).

In the image forming sections Pa to Pd, there are respectively provided photosensitive drums 1a to 1d which are rotatably arranged, chargers which electrostatically charge the photosensitive drums 1a to 1d, an exposure device which exposes the photosensitive drums 1a to 1d to light of image information, developing devices 3a, 3b, 3c, and 3d which form toner images on the photosensitive drums 1a to 1d, and cleaning portions which remove the developer (toner) and the like that are left behind on the photosensitive drums 1a to 1d.

When image data is fed in from a host device such as a personal computer, electrostatic latent images are formed on the photosensitive drums 1a to 1d according to the image data. The developing devices 3a to 3d are charged with predetermined amounts of two-component developer containing toner of different colors, namely cyan, magenta, yellow, and black respectively. When the proportions of toner in the two-component developer contained in the developing devices 3a to 3d fall below a prescribed value, the developing devices 3a to 3d are replenished with toner from corresponding toner containers 4a to 4d. The toner in the developer is fed by the developing devices 3a to 3d to the corresponding ones of the photosensitive drums 1a to 1d and electrostatically adheres to them, thereby forming toner images according to the electrostatic latent images formed by exposure to light from the exposure device.

The cyan, magenta, yellow, and black toner images on the photosensitive drums 1a to 1d are then primarily transferred to the intermediary transfer belt 8. These images of four colors are formed in a predetermined positional relationship that is previously determined for the formation of a predetermined full-color image.

When the intermediary transfer belt 8 starts to rotate counter-clockwise as a driving roller 11 rotates by being driven by a driving motor (unillustrated), a transfer sheet P in a sheet cassette 16 is conveyed, with predetermined timing, to a nip portion (secondary transfer nip portion) between the driving roller 11 and a secondary transfer roller 9 provided next to it, and the full-color image on the intermediary transfer belt 8 is transferred to the transfer sheet P. The transfer sheet P having the toner images transferred to it passes through a sheet conveying passage 18 and is conveyed to a fixing unit 13.

The transfer sheet P conveyed to the fixing unit 13 is heated and pressed by a pair of fixing rollers so that the toner images are fixed to the surface of the transfer sheet P, and thereby the predetermined full-color image is formed on the transfer sheet P. The transfer sheet P having the full-color image formed on it is distributed between different conveying directions by a branch portion 14 which branches into a plurality of directions, so as to be discharged as it is (or after being conveyed to a two-sided conveying passage 20 and having undergone two-sided printing) onto a discharge tray 17 by a pair of discharge rollers 15.

Next, a container lock mechanism 30 including relay connectors 52a to 52d will be described.

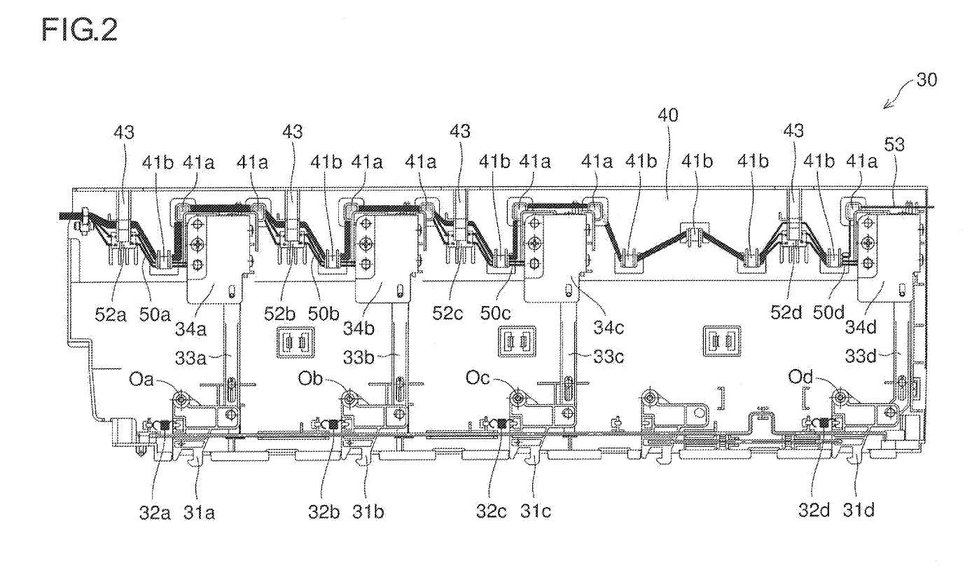

The container lock mechanism 30 is arranged over the toner containers 4a to 4d, and serves to lock the toner containers 4a to 4d to prevent them from being detached from the main body of the image forming apparatus 100. Specifically, as shown in FIG. 2, the container lock mechanism 30 includes a chassis 40 made of resin, hook members 31a to 31d which engage with the toner containers 4a to 4d, biasing members 32a to 32d which bias the hook members 31a to 31d in a predetermined direction, link members 33a to 33d which engage with the hook members 31a to 31d, and solenoids 34a to 34d which engage with the link members 33a to 33d, respectively.

The hook members 31a to 31d are formed so as to be swingable about pivots Oa to Od, respectively. The biasing members 32a to 32d comprise extension coil springs, and bias the hook members 31a to 31d clockwise in FIG. 2, respectively. This permits the hook members 31a to 31d to engage with the toner containers 4a to 4d, respectively, so that, when the solenoids 34a to 34d are in the off state, the toner containers 4a to 4d cannot be detached. On the other hand, when the solenoids 34a to 34d are in the on state, the link members 33a to 33d are pulled by the solenoids 34a to 34d to move upward in FIG. 2, respectively, so that, against the biasing forces of the biasing members 32a to 32d, the hook members 31a to 31d swing counter-clockwise in FIG. 2, respectively. This permits the hook members 31a to 31d to unlock the toner containers 4a to 4d, respectively, and now the toner containers 4a to 4d can be detached from the main body of the image forming apparatus 100. The solenoids 34a to 34d can be controlled individually between the on and off states via cables 50a to 50d, respectively, which will be described below.

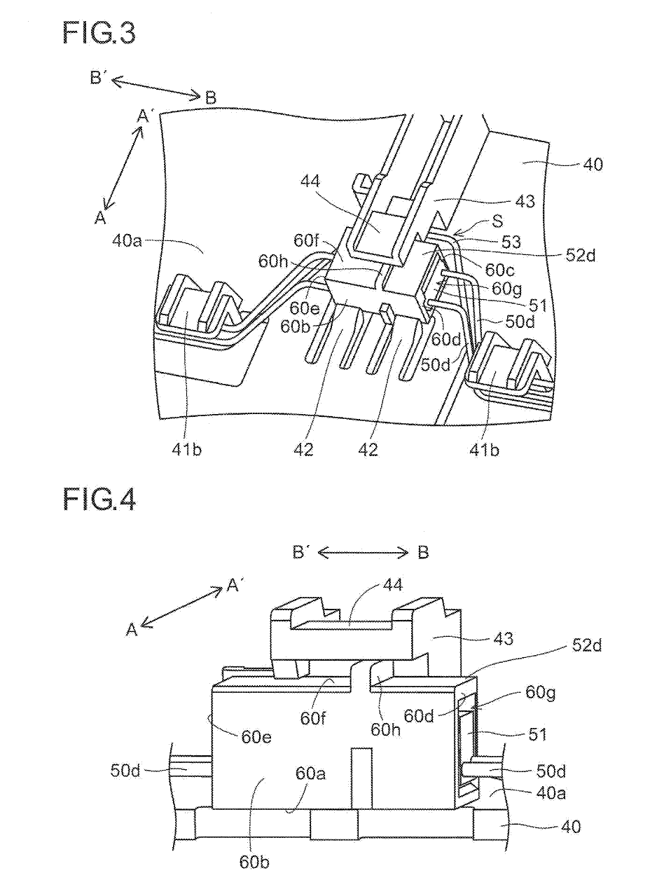

The chassis 40 is fitted with cables 50a to 50d across which the solenoids 34a to 34d are actuated. Specifically, to the solenoid 34d, two cables 50d are connected, and the cables 50d are hung on a plurality of cable engagement portions 41a and 41b provided on the chassis 40 to reach the left end of FIG. 2. The cables 50d are laid via connectors 51 (see FIG. 3) and the relay connector 52d to reach the left end of the chassis 40. A cable 53 that is not electrically connected to any of the solenoids 34a to 34d is laid from the right end to the left end of the chassis 40, passing by the solenoid 34d on the way. The cables 50d and the cable 53 take separate paths near the relay connector 52d, and then join to take the same path.

To the solenoid 34c, two cables 50c are connected, and the cables 50c are hung on a plurality of cable engagement portions 41a and 41b to reach the left end of FIG. 2. The cables 50c are laid via connectors 51 and the relay connector 52c to reach the left end of the chassis 40. The cables 50c and the cables 50d and 53 take separate paths near the relay connector 52c, and then join to take the same path.

To the solenoid 34b, two cables 50b are connected, and the cables 50b are hung on a plurality of cable engagement portions 41a and 41b to reach the left end of FIG. 2. The cables 50b are laid via connectors 51 and the relay connector 52b to reach the left end of the chassis 40. The cables 50b and the cables 50c, 50d, and 53 take separate paths near the relay connector 52b, and then join to take the same path.

To the solenoid 34a, two cables 50a are connected, and the cables 50a are hung on a cable engagement portion 41b to reach the left end of FIG. 2. The cables 50a are laid via connectors 51 and the relay connector 52a to reach the left end of the chassis 40. The cables 50a and the cables 50b, 50c, 50d, and 53 take separate paths near the relay connector 52a, and are bundled together in a left end part of the chassis 40.

Next, the structure around the relay connector 52d will be described in detail. While the following description takes up, as an example, the structure around the relay connector 52d, the structures around the relay connectors 52a to 52c are basically the same, and therefore overlapping description will be omitted.

As shown in FIGS. 3 and 4, the relay connector 52d has a facing surface 60a (bottom surface) arranged to face a fitting surface 40a (top surface) of the chassis 40, a plurality of side surfaces (first to fourth side surfaces 60b to 60e) arranged upright from the end edges of the facing surface 60a, and an opposite surface 60f (top surface) arranged opposite from the facing surface 60a. The plurality of side surfaces include a first side surface 60b arranged in the arrow-A direction (first direction), a second side surface 60c arranged in the arrow-A′ direction (second direction) opposite to the arrow-A direction, a third side surface 60d arranged in the arrow-B direction (third direction, the direction perpendicular to the arrows-AA′ direction), and a fourth side surface 60e arranged in the arrow-B′ direction (fourth direction) opposite to the arrow-B direction.

In the third and fourth side surfaces 60d and 60e, fitting recesses 60g are respectively formed in which connectors 51 are fitted. The opposite surface 60f has a protrusion 60h that protrudes to the side (top side) opposite from the facing surface 60a.

The connectors 51 are provided at end parts of the cables 50d, and are configured to be removably fitted in the fitting recesses 60g of the relay connector 52d.

The chassis 40 has, formed integrally with it, two first stoppers 42 which are arranged to face the first side surface 60b of the relay connector 52d and which restrict movement of the relay connector 52d in the arrow-A direction, a second stopper 43 which is arranged to face the second side surface 60c and which restricts movement of the relay connector 52d in the arrow-A′ direction, and an opposite surface stopper 44 which is arranged to face the opposite surface 60f and which restricts movement of the relay connector 52d to the side (top side) opposite from the fitting surface 40a.

Tip parts of the first stoppers 42 protrude upward from the fitting surface 40a. Moreover, as shown in FIG. 5, as a result of a part around the first stopper 42 being cut out, the first stoppers 42 are formed to have a snap-fit structure elastically deformable in the thickness direction of the chassis 40. In the state shown in FIG. 3 (with the relay connector 52d fitted to the chassis 40), the first stoppers 42 are arranged with a predetermined gap left from, or in contact with, the first side surface 60b of the relay connector 52d.

As shown in FIG. 3, the second stopper 43 protrudes upward from the fitting surface 40a of the chassis 40, and has an upper part thereof formed to extend toward the second side surface 60c of the relay connector 52d. Thus, between the second stopper 43 and the second side surface 60c of the relay connector 52d, a gap S is formed that is passable in the arrows-BB′ direction. Through this gap S is laid the cable 53 (non-connector cable), which is not connected to the connectors 51 and the relay connector 52d. Moreover, in the state shown in FIG. 3, the second stopper 43 is arranged with a predetermined gap left from, or in contact with, the second side surface 60c of the relay connector 52d.

The opposite surface stopper 44 is formed to be continuous with a tip part of the second stopper 43. In the state shown in FIG. 4 (with the relay connector 52d fitted to the chassis 40), the opposite surface stopper 44 is arranged with a predetermined gap left from, or in contact with, the protrusion 60h on the opposite surface 60f of the relay connector 52d.

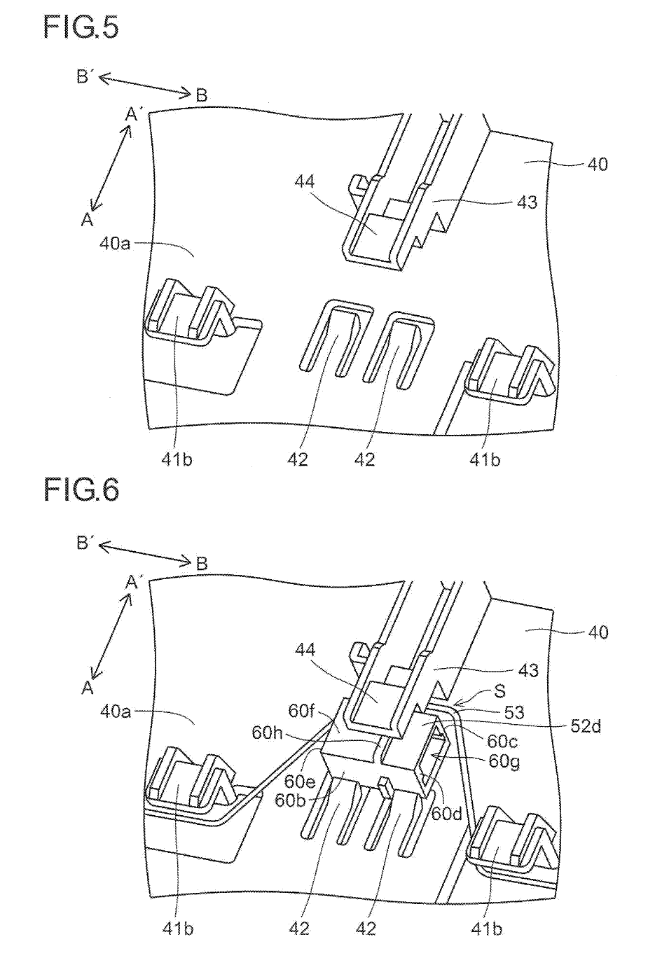

When the relay connector 52d is fitted to the chassis 40, first the cable 53 is hung on the cable engagement portions 41a and 41b, and then the relay connector 52d is slid in the arrow-A′ direction so as to pass over the first stoppers 42. This causes the first stoppers 42 to elastically deform downward, and when the relay connector 52d has run over the first stoppers 42, the first stoppers 42 is restored to the original state as shown in FIG. 6 so as to restrict movement of the relay connector 52d in the arrow-A direction. Now the cable 53 remains laid through the gap S between the relay connector 52d and the second stopper 43. Thereafter, the connectors 51 are fitted in the fitting recesses 60g from the arrow-B and arrow-B′ directions, resulting in the state shown in FIG. 3.

In this embodiment, as described above, the chassis 40 has, formed integrally with it, the first stoppers 42 which restrict movement of the relay connectors 52a to 52d in the arrow-A direction, the second stoppers 43 which restrict movement of the relay connectors 52a to 52d in the arrow-A′ direction, and the opposite surface stoppers 44 which restrict movement of the relay connectors 52a to 52d to the side opposite from the fitting surface 40a. Thus, it is possible, without providing extra fitting members such as screws and hooks, to fit the relay connectors 52a to 52d to the chassis 40 by use of the first stoppers 42, the second stoppers 43, and the opposite surface stoppers 44 which are formed integrally with the chassis 40. This helps suppress an increase in the number of components, and helps enhance the ease of fitting the relay connectors 52a to 52d to the chassis 40.

Moreover, as described above, the cable 53 is laid through the gap S between the second stoppers 43 and the relay connectors 52a to 52d. Thus, the cable 53, which is not connected to the connectors 51, can be fastened with the chassis 40 combined with the relay connectors 52a to 52d. That is, it is possible, without providing extra members, to fasten the cable 53 to the chassis 40, and this helps further suppress an increase in the number of components.

Moreover, as described above, the first stoppers 42 protrude from the fitting surface 40a, and are formed, as a result of parts around the first stoppers 42 being cut out, to be elastically deformable in the thickness direction of the chassis 40. This helps enhance the ease of fitting and removal of the relay connectors 52a to 52d to and from the chassis 40.

Moreover, as described above, the opposite surface stoppers 44 are formed to be continuous with the second stoppers 43. This helps save space as compared with forming the second stoppers 43 and the opposite surface stoppers 44 separately.

### Second Embodiment

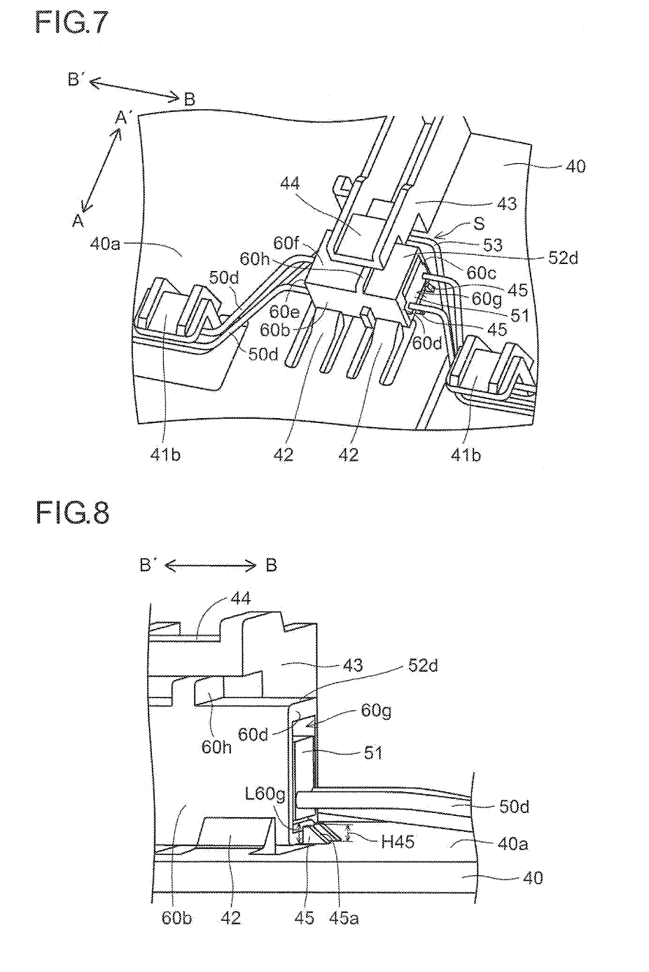

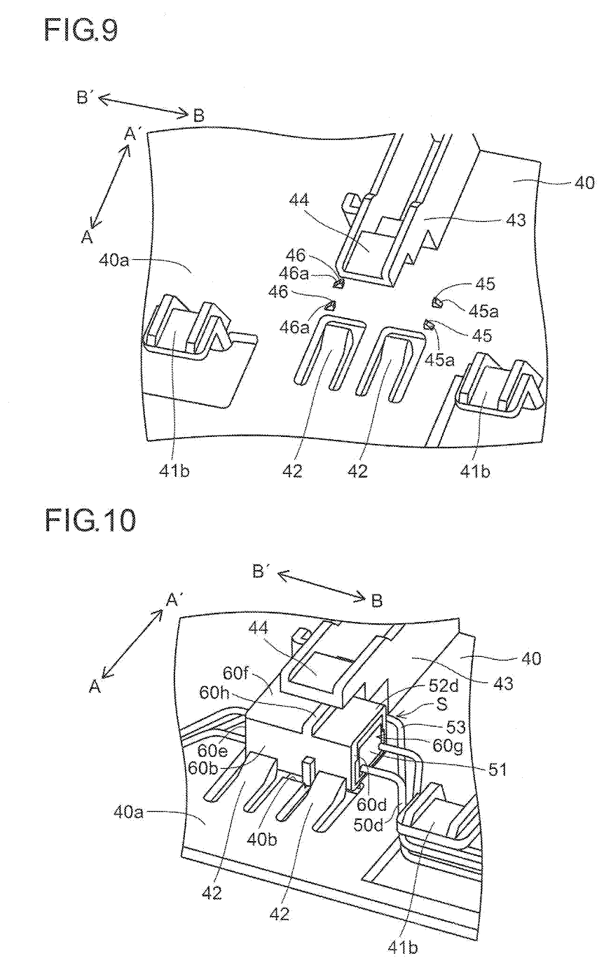

According to a second embodiment of the present disclosure, as shown in FIGS. 7 to 9, the chassis 40 has, integrally formed with it, two third stoppers 45 which are arranged to face the third side surface 60d of the relay connector 52d and which restrict movement of the relay connector 52d in the arrow-B direction and two fourth stoppers 46 which are arranged to face the fourth side surface 60e and which restrict movement of the relay connector 52d in the arrow-B′ direction.

On the third and fourth stoppers 45 and 46, there are respectively formed inclined surfaces 45a and 46b which guide the connectors 51 into the fitting recesses 60g. Moreover, as shown in FIG. 8, the protrusion height H45 of the third stoppers 45 relative to the fitting surface 40a is smaller than the distance L60g from the fitting surface 40a to the fitting recesses 60g. The fourth stoppers 46 are formed symmetrically with the third stoppers 45 about the arrows-BB′ direction, and the protrusion height (=H45) of the fourth stoppers 46 relative to the fitting surface 40a is smaller than the distance L60g from the fitting surface 40a to the fitting recesses 60g.

In other respects in terms of structure, the second embodiment is similar to the first embodiment described previously.

In this embodiment, as described above, the chassis 40 has, integrally formed with it, the third stoppers 45 which restrict movement of the relay connectors 52a to 52d in the arrow-B direction and the fourth stoppers 46 which restrict movement of the relay connectors 52a to 52d in the arrow-B′ direction. Thus, it is possible also to suppress movement of the relay connectors 52a to 52d in the arrows-BB′ direction relative to the chassis 40.

Moreover, as described above, in a case where the fitting recesses 60g are formed in the third and fourth side surfaces 60d and 60e of the relay connectors 52a to 52d, when the connectors 51 are fitted to and removed from the relay connectors 52a to 52d, the relay connectors 52a to 52d move easily in the arrows-BB′ direction; thus, providing the third and fourth stoppers 45 and 46 on the chassis 40 is particularly effective.

Moreover, as described above, on the third and fourth stoppers 45 and 46, there are respectively formed the inclined surfaces 45a and 46b which guide the connectors 51 into the fitting recesses 60g. This helps further enhance the ease of fitting the connectors 51 to the relay connectors 52a to 52d.

Moreover, as described above, the protrusion height H45 of the third and fourth stoppers 45 and 46 relative to the fitting surface 40a is smaller than the distance L60g from the fitting surface 40a to the fitting recesses 60g. This helps suppress a lowering in the ease of fitting and removal of the connectors 51 to and from the relay connectors 52a to 52d.

In other respects in terms of benefits, the second embodiment is similar to the first embodiment described previously.

### Third Embodiment

According to a third embodiment of the present disclosure, as shown in FIGS. 10 to 12, a region of the fitting surface 40a of the chassis 40 where the relay connector 52d is arranged is formed to be recessed in the thickness direction of the chassis 40. Thus, in edge parts of the region of the fitting surface 40a where the relay connector 52d is arranged, there are formed a first step 40b which is arranged to face the first side surface 60b, a second step 40c (second stopper) which is arranged to face the second side surface 60c, a third step 40d (third stopper) which is arranged to face the third side surface 60d, and a fourth step 40e (fourth stopper) which is arranged to face the fourth side surface 60e.

The second step 40c restricts movement of the relay connector 52d in the arrow-A′ direction. The third step 40d restricts movement of the relay connector 52d in the arrow-B direction. The fourth step 40e restricts movement of the relay connector 52d in the arrow-B′ direction.

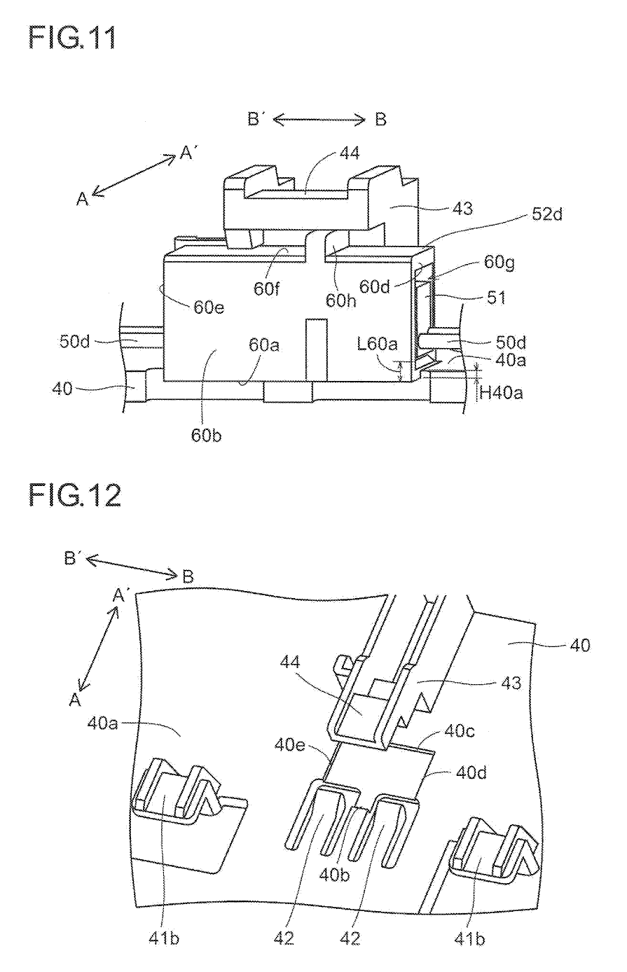

Moreover, as shown in FIG. 11, the height difference H40a between the region of the fitting surface 40a where the relay connector 52d is arranged and the part surrounding it is smaller than the distance L60a (=L60g) from the facing surface 60a of the relay connector 52d to the fitting recesses 60g.

In other respects in terms of structure, the third embodiment is similar to the first embodiment described previously.

In this embodiment, as described above, the regions of the fitting surface 40a where the relay connectors 52a to 52d are arranged are formed to be recessed in the thickness direction of the chassis 40, and the third and fourth steps 40d and 40e are constituted by the steps formed in edge parts of the regions of the fitting surface 40a where the relay connectors 52a to 52d are arranged. Thus, it is possible to easily suppress movement of the relay connectors 52a to 52d in the arrows-BB′ direction.

Moreover, as described above, the height difference H40a between the regions of the fitting surface 40a where the relay connectors 52a to 52d are arranged and the parts surrounding them is smaller than the distance L60a from the facing surfaces 60a of the relay connectors 52a to 52d to the fitting recesses 60g. This helps suppress a lowering in the ease of fitting and removal of the connectors 51 to and from the relay connectors 52a to 52d.

In other respects in terms of benefits, the third embodiment is similar to the first and second embodiments described previously.

The embodiments disclosed herein should be understood to be in every respect illustrative and not restrictive. The scope of the present disclosure is not defined by the description of embodiments given above but by the appended claims, and encompasses any modifications made in the sense and scope equivalent to those of the claims.

For example, although the above description deals with examples where the present disclosure is applied to an image forming apparatus, this is not meant to limit the application of the present disclosure. Needless to say, the present disclosure is applicable to a variety of electronic appliances provided with a structure for fitting relay connectors.

Although the above embodiments deal with examples where the cable 53 is taken as a non-connector cable that is not connected to the connectors 51, this is not meant to limit the implementation of the present disclosure. As a matter of fact, around the relay connector 52c, the cables 50d and 53 are non-connector cables; around the relay connector 52b, the cables 50c, 50d, and 53 are non-connector cables; and around the relay connector 52a, the cables 50b, 50c, 50d, and 53 are non-connector cables.

What is claimed is:

1. A relay connector fitting structure, comprising:
a connector provided at an end part of a cable;
a relay connector to which, as the connector, a plurality of connectors are removably fitted; and
a chassis having a fitting surface to which the relay connector is fitted,
wherein
the relay connector has
a facing surface arranged to face the fitting surface,
a plurality of side surfaces arranged upright from end edges of the facing surface, and
an opposite surface arranged on a side opposite from the facing surface, the chassis has, formed integrally therewith,
a first stopper arranged to face a first side surface, which is one of the plurality of side surfaces of the relay connector arranged in a first direction, the first stopper restricting movement of the relay connector in the first direction,
a second stopper arranged to face a second side surface, which is one of the plurality of side surfaces of the relay connector arranged in a second direction opposite to the first direction, the second stopper restricting movement of the relay connector in the second direction, and
an opposite surface stopper arranged to face the opposite surface of the relay connector, the opposite surface stopper restricting movement of the relay connector to a side opposite from the fitting surface.

2. The relay connector fitting structure of claim 1, further comprising:
a non-connector cable not connected to the connector,
wherein the non-connector cable is laid in a gap between the second stopper and the relay connector.

3. The relay connector fitting structure of claim 1, wherein
the first stopper protrudes from the fitting surface and is formed, as a result of a part around the first stopper being cut out, to be elastically deformable in a thickness direction of the chassis.

4. The relay connector fitting structure of claim 1, wherein
the opposite surface stopper is formed to be continuous with the second stopper.

5. The relay connector fitting structure of claim 1, wherein
the chassis further has, formed integrally therewith,
a third stopper arranged to face a third side surface, which is one of the plurality of side surfaces of the relay connector arranged in a third direction perpendicular to the first and second directions, the third stopper restricting movement of the relay connector in the third direction, and
a fourth stopper arranged to face a fourth side surface, which is one of the plurality of side surfaces of the relay connector arranged in a fourth direction opposite to the third direction, the fourth stopper restricting movement of the relay connector in the fourth direction.

6. The relay connector fitting structure of claim 5, wherein
the third and fourth side surfaces of the relay connector respectively have fitting recesses formed therein in which the connectors are fitted.

7. The relay connector fitting structure of claim 6, wherein
the third and fourth stoppers respectively have inclined surfaces formed thereon which guide the connectors into the fitting recesses.

8. The relay connector fitting structure of claim 6, wherein
a protrusion height of the third and fourth stoppers relative to the fitting surface is smaller than a distance from the fitting surface to the fitting recesses.

9. The relay connector fitting structure of claim 5, wherein
a region of the fitting surface in which the relay connector is arranged is formed to be recessed in a thickness direction of the chassis, and
the third and fourth stoppers are constituted by steps formed in edge parts of the region of the fitting surface in which the relay connector is arranged.

10. The relay connector fitting structure of claim 9, wherein
the third and fourth side surfaces of the relay connector respectively have fitting recesses formed therein in which the connectors are fitted, and
a height difference between the region of the fitting surface in which the relay connector is arranged and a part surrounding the region is smaller than a distance from the facing surface of the relay connector to the fitting recesses.

11. An electronic appliance, comprising the relay connector fitting structure of claim 1.

12. An image forming apparatus, comprising:
the relay connector fitting structure of claim 1; and
an image forming section for forming an image.
